(19) United States
(12) Patent Application Publication
(10) Pub. No.: US 2006/0191696 A1
(43) Pub. Date: Aug. 31, 2006

(54) Air inlet structure for a pneumatic tool

(76) Inventors: Rick Lin, Taichung (TW); Hwa Chiang, Taichung (TW)

Correspondence Address: CHARLES E. BAXLEY, ESQ., 90 JOHN STREET, THIRD FLOOR, NEW YORK, NY, 10038, US

(21) Appl. No.: 11/413,510

(22) Filed: Apr. 28, 2006

Related U.S. Application Data
(63) Continuation-in-part of application No. 10/978,063, filed on Oct. 28, 2004.

(51) Int. Cl. B25D 11/00

(52) U.S. Cl. 173/104

(57) ABSTRACT

The present invention relates to an air inlet structure for a pneumatic tool, in which, an inlet pipe are inserted in the inlet hole of the switch seat of the pneumatic motor and in the through hole of the air chamber of the pneumatic tool, respectively, on the both ends of the inlet pipe are formed with plural grooves for reception of O-shaped rings which are used to prevent air-leakage from clearances between the pneumatic tool and the inlet pipe, and between the switch seat and the inlet pipe.

The present application is a continuation-in-part application Ser. No. 10/978,063 filed on 28 Oct. 2004.

### BACKGROUND OF THE INVENTION

1. Field of the Invention

This invention relates to an air inlet structure for a pneumatic tool that is capable of preventing air-leakage during air-transmission.

2. Description of the Prior Arts

With the development of the science and technology, many kinds of hand tools have been developed to improve the applicability, pneumatic tool is one of them.

Air-transmission for a conventional pneumatic tool generally includes a through hole formed on a handle portion of a pneumatic tool, and a first end of the through hole is connected to an air supply by means of an inlet screw. A second end of the through hole is connected to an air chamber of the pneumatic tool. In the air chamber of the pneumatic tool is disposed with a pneumatic motor having a two-way rotary valve. The two-way rotary valve is provided with a switch seat that is formed with an air inlet hole corresponding to the through hole of the air chamber of the pneumatic tool. The switch seat is positioned beside the through hole, such that air can be transmitted, via the inlet hole of the switch seat, from the through hole of the pneumatic tool to the pneumatic motor.

However, when assembling the pneumatic motor to the air chamber of the pneumatic tool, the inlet hole of the switch seat of the pneumatic motor should be very precisely aligned to the through hole of the air chamber of the pneumatic tool. Not only the assembly is not easy, but also clearances are likely caused in case of misalignment, which will lead to an air leakage during air-transmission.

U.S. Pat. No. 4,165,203 discloses another air-transmission structure of a pneumatic tool. The air-transmission structure serves to transmit air from a control housing to the pneumatic motor and comprises an air guide drum, an air guide element, and a plurality of sealing rings therebetween. A plurality of air channels in the air guide element cooperate with a corresponding number of recesses in the air guide drum to form an air-transmission channel for transmitting air from the control housing to the pneumatic motor. The air-transmission structure also has its disadvantages as follows:

First, the air-transmission structure is too complicated since it consists of the air guide element and the air guide drum.

Second, the size of the air guide drum and the air guide element must be controlled very precisely during production, otherwise, they can't fit closely with each other to ensure an air-tightness effect. This imposes a strict requirement on production, and the resultant production cost is high.

Third, even if the size is precisely controlled, the air guide drum and the air guide element must be assembled very accurately to ensure that the plurality of air channels in the air guide element must be strictly aligned with the corresponding recesses in the air guide drum, otherwise, the occurrence of air leakage will be unavoidable. Hence, this air transmission structure is difficult to assemble.

Fourth, the more the number of the parts of the air transmission structure, the more difficult it is to ensure an air-tightness effect, since the air is probably leaked from the connection between the pneumatic motor and the air guide drum, between the air guide drum and the air guide element, between the air guide element and the control housing. Any of these connections is not assembled well, air leakage will occur.

The present invention has arisen to mitigate and/or obviate the afore-described disadvantages of the conventional inlet structure for a pneumatic tool.

### SUMMARY OF THE INVENTION

The primary object of the present invention is to provide a simply-structured air transmission structure for a pneumatic tool, wherein the air transmission structure is an unitary structure being in the form of an inlet pipe inserted in the inlet hole of the switch seat of the pneumatic motor and in the through hole of the air chamber of the pneumatic tool, respectively. On both ends of the inlet pipe are formed with plural grooves for reception of O-shaped rings which are used to prevent air-leakage from clearance between the pneumatic tool and the inlet pipe, and from-clearance between the switch seat and the inlet pipe.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a pneumatic tool with an air inlet structure in accordance with the present invention;

FIG. 2 is an assembly cross sectional view of a pneumatic tool with an air inlet structure in accordance with the present invention;

FIG. 3 is an exploded view of a pneumatic tool with an air inlet structure in accordance with another embodiment of the present invention;

FIG. 4 is an assembly cross sectional view of a pneumatic tool with an air inlet structure in accordance with another embodiment of the present invention.

### DETAILED DESCRIPTION OF THE PREFERRED EMBODIMENTS

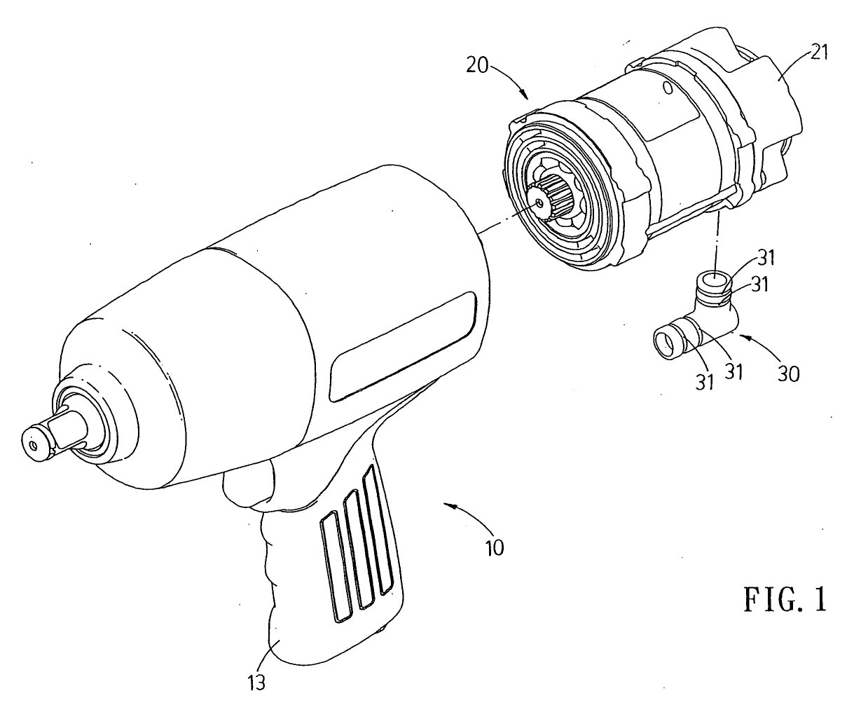

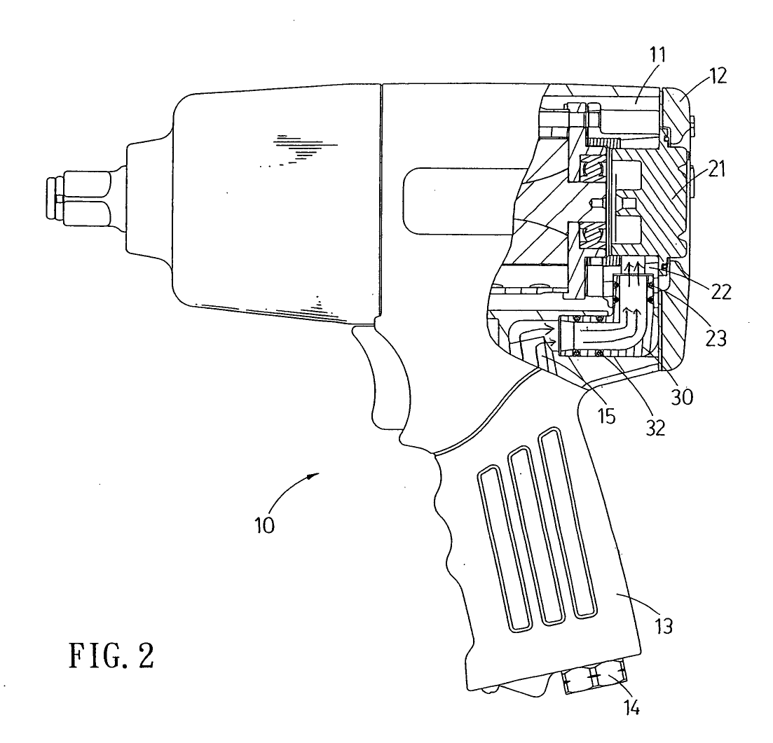

Referring to FIGS. 1 and 2, an air inlet structure for a pneumatic tool in accordance with a first preferred embodiment of the present invention generally comprising a pneumatic tool 10, a pneumatic motor 20 and an inlet pipe 30.

The pneumatic tool 10, here takes the pneumatic spanner as an example, which is provided with an air chamber 11 that is sealed with a cover 12. An inlet screw 14 is set on the handle portion 13 of the pneumatic tool 10 and connected between an air source and a through hole 15 (not shown) of the pneumatic tool 10. An end of the through hole 15 is located in the air chamber 11. Since the rest components of the pneumatic tool 10 are known products, further remarks would be omitted.

The pneumatic motor 20 is provided with a two-way rotary valve 21 having a switch seat 22. On a side of the switch seat 22 is formed with an inlet hole 23. The pneumatic motor 20 is disposed in the air chamber 11 of the pneumatic tool 10. Since the rest components of the pneumatic tool 10 are known products, further remarks would be omitted.

The inlet pipe 30 is an integral-formed elbow pipe, both ends of which are formed with two grooves 31 respectively for reception of an “O”-shaped ring 32. A first end of the inlet pipe 30 is inserted in the through hole 15 of the pneumatic tool 10, and a second end of which is received in the inlet hole 23 of the switch seat 22 of the pneumatic motor 20.

During the assembly of the pneumatic tool 10, the pneumatic motor 20 should be assembled initially. Then the second end of the inlet pipe 30 is inserted in the inlet hole 23 of the switch seat 22. After that, the pneumatic motor 20 and the inlet pipe 30 are disposed in the air chamber 11 together. And the first end of the inlet pipe 30 is inserted in the through hole 15 of the pneumatic tool 10. Finally the air chamber 11 of the pneumatic tool 10 is sealed with the rear cover 12.

Since the inlet pipe 30 is connected to the through hole 15 of the pneumatic tool 10 and the inlet hole 23 of the switch seat 22 of the pneumatic motor 20, and the respective grooves 31 of the inlet pipe 30 are received with O-shaped rings 32 for preventing air leakage during air-transmission. In this case, the air can be exactly transmitted, via the inlet pipe 30, from the through hole 15 to the pneumatic motor 20 without leakage. Furthermore, the structural design of connecting the through hole 15 to the inlet hole 23 of the pneumatic motor 20 with the inlet pipe 30 really makes the assembly convenient and can provide a quick-positioning effect.

In addition, by arranging the inlet pipe 30 between the through hole 15 and the inlet hole 23 of the pneumatic motor 20 instead of the switch seat 22 of the conventional pneumatic motor 20 is positioned beside the through hole 15 of the pneumatic tool 10, the two-way rotary valve 21 is allowed to cut down the space that is replaced by the inlet pipe 30. Thereby, the raw material of the two-way rotary valve 21 is cut down.

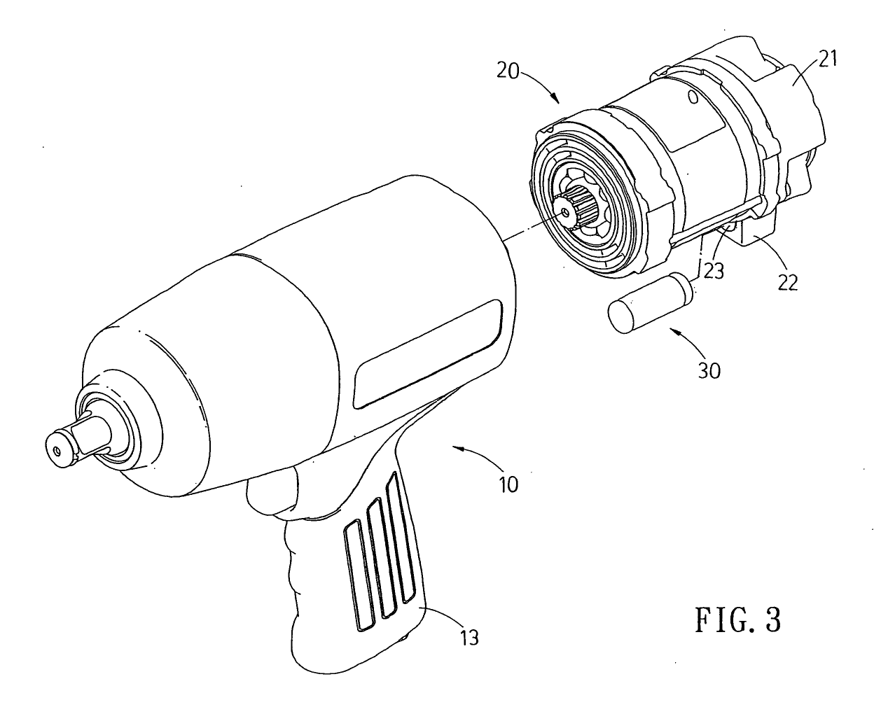

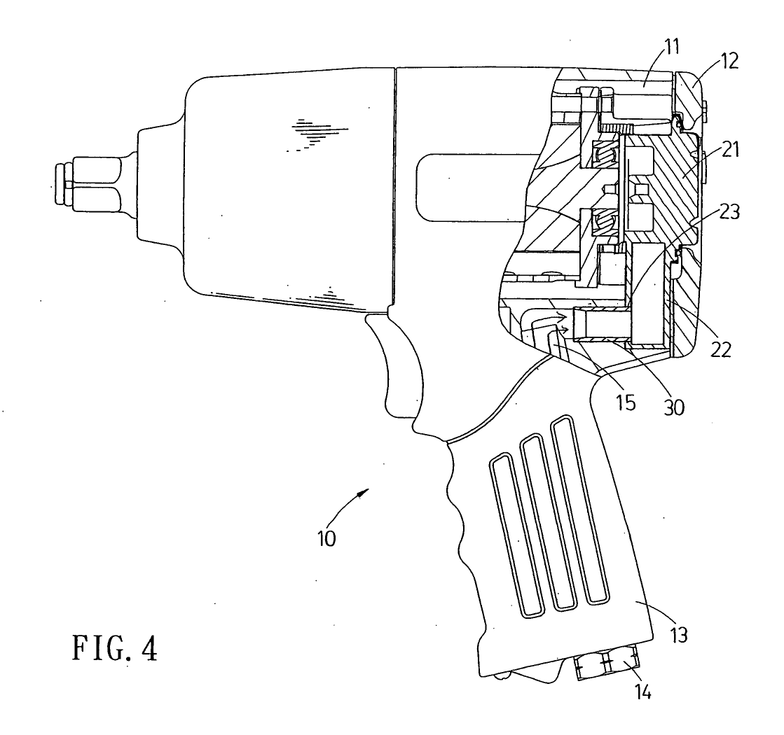

Referring to FIGS. 3 and 4, which show a second embodiment in accordance with the present invention. A two-way rotary valve 21 of the pneumatic motor 20 is provided with a switch seat 22 corresponding to the through hole 15 of the pneumatic tool 10. The switch seat 22 is axially formed with an inlet hole 23. A straight pipe 30 is connected between the inlet hole 23 of the switch seat 22 of the pneumatic motor 20 and the through hole 15 of the pneumatic tool 10. Furthermore, plural grooves can be formed on and located adjacent to the end of the inlet pipe 30 for reception of O-shaped rings (not shown) in order to improve the air-tightness of the space between the inlet hole 23 of the switch seat 22 of the pneumatic motor 20 and the through hole 15 of the pneumatic tool 10. Others assembling manners and functions of pneumatic tool in this embodiment are same as that of the first embodiment, so further descriptions would be omitted.

As compared with the prior art, the air transmission structure in accordance with the present invention has the following advantages:

First, simple structure: rather than being an assembly of parts, the air transmission structure of the present invention is a unitary structure (in the form of an air inlet pipe). Therefore, it can be produced more quickly and easily, and the air inlet pipe itself doesn't require any assembly process (since the air inlet pipe is the air transmission structure). Therefore, the resultant cost is reduced.

Second, easy assembly: since the air inlet pipe itself doesn't require any assembly process, the air transmission structure of the present invention will be finished easily just by connecting the inlet pipe directly between the pneumatic motor and the air chamber.

Third, easier to ensure an air-tightness effect: the less the number of the parts of the air transmission structure, the more easy it will be to ensure an air-tightness effect, since the air is probably leaked from the two connections only between the pneumatic motor and the inlet pipe, and between the inlet pipe and the air chamber.

While we have shown and described various embodiments in accordance with the present invention, it should be clear to those skilled in the art that further embodiments may be made without departing from the scope of the present invention.

What is claimed is:

1. An air inlet structure for a pneumatic tool comprising an inlet pipe, a first end of the inlet pipe inserted in a through hole of an air chamber of the pneumatic tool, and a second end of the inlet pipe connected to an inlet hole on a switch seat of a pneumatic motor of the pneumatic tool, thus, air is allowed to be transmitted, via the inlet pipe, from the through hole of the pneumatic tool to the pneumatic motor.

2. The air inlet structure for a pneumatic tool as claimed in claim 1, wherein the inlet hole is formed on a side of the switch seat of the pneumatic motor and connected to a second end of the inlet pipe which is elbow-shaped, a first end of the inlet pipe is connected to the through hole of the air chamber of the pneumatic tool.

3. The air inlet structure for a pneumatic tool as claimed in claim 1, wherein the switch seat is provided on a two-way rotary valve of the pneumatic motor so as to correspond to the through hole of the air chamber, the switch seat is axially formed with the inlet hole, a first end of a straight inlet pipe is connected to the through hole of the air chamber of the pneumatic tool, a second end of the straight inlet pipe is connected to the inlet hole of the switch seat of the pneumatic tool.

4. The air inlet structure for a pneumatic tool as claimed in claim 1, wherein the first end of the inlet pipe is inserted in the through hole of the air chamber of the pneumatic tool, and at the first end of the inlet pipe is formed with a groove for reception of an O-shaped ring which is used to prevent air-leakage from clearance between the pneumatic tool and the inlet pipe.

5. The air inlet structure for a pneumatic tool as claimed in claim 1, wherein the second end of the inlet pipe is inserted in the inlet hole of the pneumatic motor of the pneumatic tool, and at the second end of the inlet pipe is formed with a groove for reception of an O-shaped ring which is used to prevent air-leakage from clearance between the switch seat and the inlet pipe.

6. The air inlet structure for a pneumatic tool as claimed in claim 1, wherein the first end and the second end of the inlet pipe are inserted in the inlet hole of the switch seat of the pneumatic motor and in the through hole of the air chamber of the pneumatic tool, respectively, on each of the first end and the second end of the inlet pipe are formed with plural grooves for reception of O-shaped rings which are used to prevent air-leakage from clearances between the pneumatic tool and the inlet pipe, and between the switch seat and the inlet pipe.
